(19) United States
(12) Patent Application Publication
(10) Pub. No.: US 2002/0027533 A1
(43) Pub. Date: Mar. 7, 2002

(54) Display device and information processing apparatus

(76) Inventors: Mitsunori Shishida, Hyogo (JP); Akihiro Kuranaga, Hyogo (JP); Kazuyasu Nagatomi, Hyogo (JP)

Correspondence Address: Michael K. Kelly, SNELL & WILMER, LLP, One Arizona Center, 400 E. Van Buren Street, Phoenix, AZ, 85004-2202, US

(21) Appl. No.: 09/792,569

(22) Filed: Feb. 23, 2001

(30) Foreign Application Priority Data
Sep. 5, 2000 (JP) 2000-268253

(51) Int. Cl. G09G 5/00

(52) U.S. Cl. 345/1.3

(57) ABSTRACT

A display device includes: a support stand; an arm unit mounted on the support stand; and one or more display sections mounted on the arm unit, wherein the arm unit includes one or more arms for respectively supporting the one or more display sections, the one or more arms are rotatably attached to the arm unit so that the one or more display sections can be moved to such positions that a user can comfortably observe the one or more display sections, and the one or more display sections are each rotatably attached to a respective one of the one or more arms so that the one or more display sections can be moved to such positions that the user can comfortably observe the one or more display sections.

### BACKGROUND OF THE INVENTION

1. FIELD OF THE INVENTION

The present invention relates to a display device having a plurality of display sections and an information processing apparatus including such a display device.

2. DESCRIPTION OF THE RELATED ART

In recent years, computer software for display with a plurality of screens has been developed, and such software enables operation with simultaneous use of a plurality of display sections (see the handbook of MS WINDOWS98). However, even with the presence of such computer software, conventional display devices and computers using such computer software merely have a design in which a second separate display device is connected to an output terminal of the computer. Therefore, there are several problems as to a space for installing the device, convenience of operation, etc., and thus, such devices have not become widespread. A known device for addressing such problems is an apparatus disclosed in Japanese Laid-Open Publication No. 02-201633, in which a single apparatus includes a plurality of display sections,

Hereinafter, the conventional apparatus including a plurality of display sections which is disclosed in Japanese Laid-Open Publication No. 02-201633 will be described. FIG. 8 shows an outward appearance of a personal computer 800 which is a conventional information processing apparatus. As shown in FIG. 8, reference numeral 81 denotes a main body of a personal computer (hereinafter, referred to as “main body 81”), and display sections 82 and 83 are mounted on an upper face of the main body 81. The display sections 82 and 83 are placed side by side, and are connected with one another at side faces thereof. Furthermore, reference numeral 84 denotes a keyboard used as an input device.

Now, an operation of the conventional personal computer 800 having the above structure is described. A user inputs data or processes data displayed in the display section 82 with the keyboard 84 while referring to data displayed in the display section 83. Alternatively, the user can display two or more windows on the display sections 82 and 83 at one time, or the user can display a single large window over the display sections 82 and 83.

With the above conventional apparatus in which a single apparatus includes two display sections, even when two display sections are used at one time in operation, extension of a space on a desk for installation can be suppressed as compared to a case where a second separate display device is connected to a terminal of a computer.

However, in the above conventional personal computer 800, one of the display sections 82 and 83 is away from a location on which the main body 81 is installed, and cannot be freely moved. Therefore, when the user carries out operations with the personal computer 800, the user should change their position with respect to the main body 81 of the personal computer 800 between a case where the user uses both the display sections 82 and 83 at one time and a case where the user uses only the display section 82. Without such a change in the user's position, the user would experience discomfort during operation. However, in an actual operation environment on a desk, it is difficult for the user to change their position for operation. Moreover, the personal computer 800 always includes the two display sections 82 and 83, and one of them is of no use when the user carries out operations only with a single display section. The unused display section always consumes space.

### SUMMARY OF THE INVENTION

According to one aspect of the present invention, a display device includes: a support stand; an arm unit mounted on the support stand; and one or more display sections mounted on the arm unit, wherein the arm unit includes one or more arms for respectively supporting the one or more display sections, the one or more arms are rotatable attached to the arm unit so that the one or more display sections can be moved to such positions that a user can comfortably observe the one or more display sections, and the one or more display sections are each rotatably attached to a respective one of the one or more arms so that the one or more display sections can be moved to such positions that the user can comfortably observe the one or More display sections.

In one embodiment of the present invention, the one or more display sections are a plurality of display sections; the one or more arms are a plurality of arms; and at least one of one of the plurality of display sections and one of the plurality of arms which supports the one of the plurality of display sections is rotatable such that the one of the plurality of display sections is placed in a back-to-back position with respect to another one of the plurality of display sections.

In another embodiment of the present invention, the one or more display sections are a plurality of display sections: the one or more arms are a plurality of arms; and the plurality of display sections and the plurality of arms are rotatable such that the plurality of display sections are placed on substantially the same plane so as to face in a same direction.

In still another embodiment of the present invention, the arm unit includes: one or more first hinges for rotatably supporting the one or more arms; and one or more second hinges for rotatably supporting the one or more display sections.

In still another embodiment of the present invention, each of the one or more first hinges are provided at one end of each of the one or more arms; and each of the one or more second hinges are provided at the other end of each of the one or more arms.

In still another embodiment of the present invention, the one or more first hinges each horizontally rotatably support a respective one of the one or more arms; and the one or more second hinges each horizontally rotatably support a respective one of the one or more display sections.

In still another embodiment of the present invention, the arm unit is detachably mounted on the support stand; and the one or more display sections are detachably mounted on the arm unit.

In still another embodiment of the present invention, the support stand includes a first attaching portion; and the arm unit further includes a first engaging portion for engaging with the first attaching portion.

In still another embodiment of the present invention, the arm unit further includes one or more first attaching portions for respectively attaching the one or more display sections to the arm unit; and each of the one or more display sections includes, a first engaging portion for engaging with each of the one or more first attaching portions, a display unit for displaying information, and a first hinge for rotatably supporting the display unit.

In still another embodiment of the present invention, the support stand includes a second attaching portion for attaching the arm unit to the support stand; the arm unit includes a second engaging portion for detachably engaging with the second attaching portion included in the support stand: each of the first engaging portions included in each of the one or more display sections detachably engages with each of the one or more first attaching portions included in the arm unit; and the second engaging portion included in the arm unit and the first engaging portion included in each of the plurality of display sections have a substantially identical shape.

In still another embodiment of the present invention, the first engaging portion included in one of the one or more display sections which has been detached from one of the one or more first attaching portions included in the arm unit engages with the second attaching portion included in the support stand from which the second engaging portion included in the arm unit has been detached.

In still another embodiment of the present invention, the first hinge horizontally rotatably supports the display unit.

In still another embodiment of the present invention, each of the one or more display sections further includes a second hinge for supporting the display unit rotatably in a tilting direction.

In still another embodiment of the present invention, the first hinge is provided between the first engaging portion and the second hinge.

In still another embodiment of the present invention, each of the display sections includes a slide section for vertically sliding up and down the display unit.

In still another embodiment of the present invention, the arm unit includes a slide section for vertically sliding up and down the one or more arms.

In still another embodiment of the present invention, the one or more arms are a plurality of arms; the plurality of arms are all placed at a same height; and the plurality of arms are horizontally rotatably attached to the arm unit.

In still another embodiment of the present invention, the one or more display sections are a plurality of display sections; one of the plurality of display sections includes a first connecting portion; and another one of the plurality of display sections which is adjacent to the one of the plurality of display sections includes a second connecting portion formed so as to connect with the first connecting portion.

In still another embodiment of the present invention, the first connecting portion has a protruding shape; and the second connecting portion has a concave shape which engages with the, protruding shape of the first connecting portion.

In still another embodiment of the present invention, the first connecting portion includes a first magnet; and the second connecting portion includes a second magnet having a polarity opposite to that of the first magnet.

In still another embodiment of the present invention, each of the one or more display sections has speakers at right and left sides thereof; and when one of the one or more display sections is connected to another one of the one or more display sections, speakers of the connected display sections which are present near an interface between the connected display sections are turned off.

In still another embodiment of the present invention, each of the one or more display sections includes elastic bodies at corner areas thereof.

In still another embodiment of the present invention, the one or more display sections are one display section; and the one or more arms are one arm.

According to another aspect of the present invention, a display device includes: a support stand; and a display section mounted on the support stand, wherein the support stand includes a first attaching portion for detachably attaching the display section to the support stand, the display section includes a first engaging portion for detachably engaging with the first attaching portion, the first attaching portion included in the support stand can engage with a second engaging portion included in an arm unit, a second attaching portion included in the arm unit can engage with the first engaging portion included in the display section, and the first engaging portion included in the display section and the second engaging portion included in the arm unit have a substantially identical shape.

According to still another aspect of the present invention, an information processing apparatus, comprising: a support stand; an arm unit mounted on the support stand, one or more display sections mounted on the arm unit; and one or more CPUs for controlling the one or more display sections, wherein the arm unit includes one or more arms for respectively supporting the one or more display sections, the one or more arms are rotatably attached to the arm unit so that the one or more display sections can be moved to such positions that a user can comfortably observe the one or more display sections, and the one or more display sections are rotatably attached to the one or more arms so that the one or more display sections can be moved to such positions that the user can comfortably observe the one or more display sections.

In one embodiment of the present invention, the one or more CPUs are one CPU; and the one CPU controls the one or more display sections.

In another embodiment of the present invention, the one or more CPUs are a plurality of CPUs; and the plurality of CPUs respectively control the one or more display sections.

According to one aspect of the present invention, there are provided a display device and an information processing apparatus in which an operation environment can be improved: for example, the degree of freedom of the position of the display sections is increased without increasing a space on a desk for installing devices; and the number of display sections can be changed according to the operation mode of the display sections.

According to another aspect of the present invention, a position of a display section can be freely changed along a horizontal direction.

According to still another aspect of the present invention, an angle of a display section can be freely changed.

According to still another aspect of the present invention, in place of an arm unit, a display section can be attached to a first attaching portion of a support stand.

According to still another aspect of the present invention, a plurality of display sections can be attached to a single attaching portion of a support stand through an arm unit.

According to still another aspect of the present invention, a plurality of display sections can be rotated so as to be at the same height while the plurality of display sections can be placed on the same plane by means of rotation of both hinge portions.

According to still another aspect of the present invention, an angle of each display section can be separately adjusted.

According to still another aspect of the present invention, a plurality of display sections can be placed on the same plane even when they are tilted.

According to still another aspect of the present invention, the height of all of the display sections can be simultaneously adjusted.

According to still another aspect of the present invention, the height of each display section can be separately adjusted.

According to still another aspect of the present invention, the position of a plurality of display sections can be changed while the plurality of display sections are maintained on the same plane.

According to still another aspect of the present invention, a plurality of display sections can be maintained on the same plane by connecting portions having simple shapes.

According to still another aspect of the present invention, a plurality of display sections can be maintained on the same plane by an attraction power of magnets.

According to still another aspect of the present invention, when a display section is connected to another display section, speakers of the connected display sections which are present near an interface between the connected display sections are turned off, whereby stereophonic sound can be normally output from the display sections.

According to still another aspect of the present invention, when display sections are moved, breakage of a display section which may be caused by being contacted by another display section is prevented.

Thus, the invention described herein makes possible the advantages of: (1) providing a display device and an information processing apparatus including a plurality of display sections in which a degree of freedom of the position of the display sections is increased; and (2) providing a display device and an information processing apparatus in which the number of display sections can be changed according to the operation mode of the display sections.

These and other advantages of the present invention will become apparent to those skilled in the art upon reading and understanding the following detailed description with reference to the accompanying figures.

### BRIEF DESCRIPTION OF THE DRAWINGS

FIG. 1 is a perspective view showing an outward appearance of a personal computer according to one embodiment of the present invention.

FIG. 2 is a perspective view showing an outward appearance of a main body of the personal computer according to one embodiment of the present invention.

FIG. 3 is a perspective view showing an outward appearance of an arm unit according to one embodiment of the present invention.

FIG. 4 is a perspective view showing an outward appearance of a display section according to one embodiment of the present invention.

FIG. 5 is a perspective view showing an exemplary arrangement of display sections of a personal computer according to one embodiment of the present invention when a direction of a face of one display section is changed.

FIG. 6 is a perspective view showing another exemplary arrangement of display sections of a personal computer according to one embodiment of the present invention when a direction of a face of one display section is changed.

FIG. 7 is a perspective view showing an outward appearance of a personal computer according to one embodiment of the present invention when a display section is directly mounted on a main body of the personal computer.

FIG. 8 is a perspective view showing an outward appearance of a conventional personal computer.

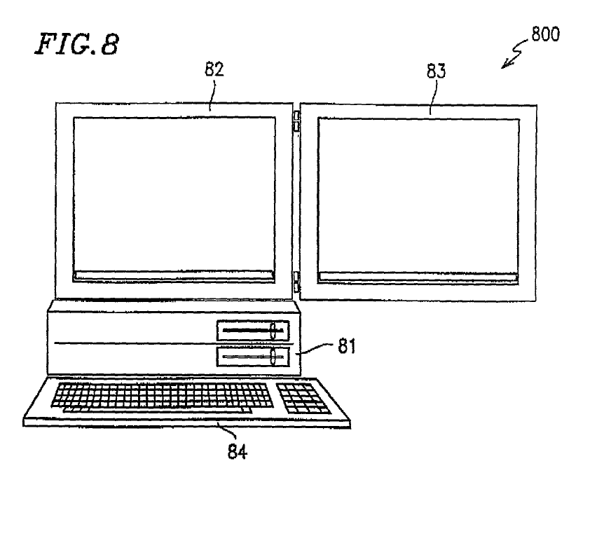

### DESCRIPTION OF THE PREFERRED EMBODIMENTS

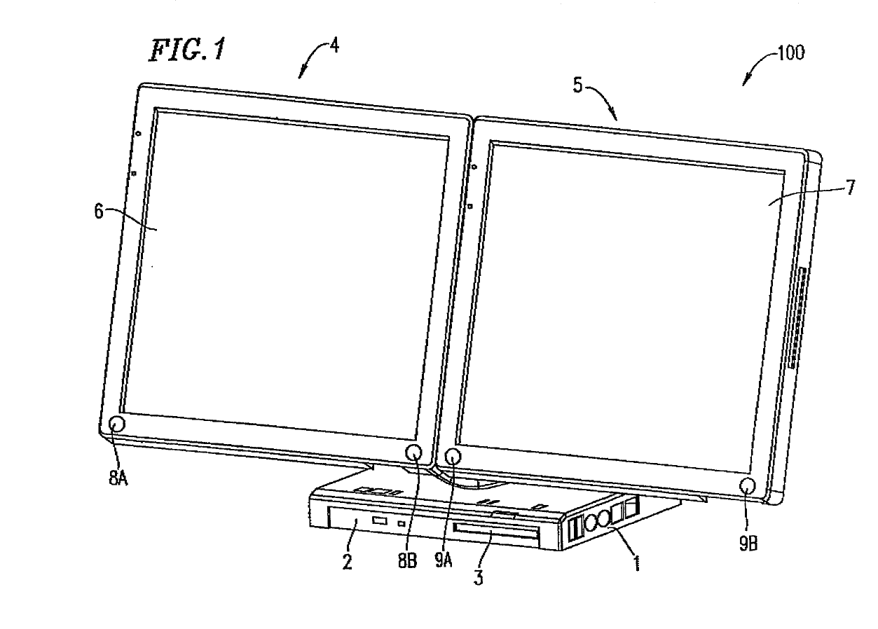

Hereinafter, an embodiment of the present invention will be described with reference to FIGS. 1 through 7.

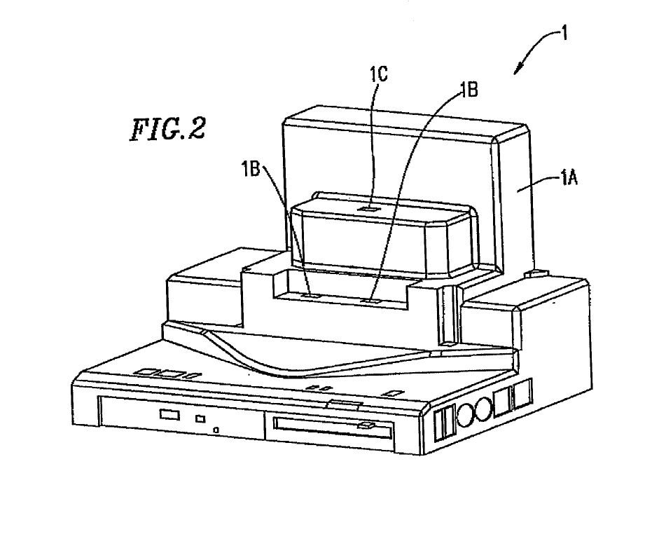

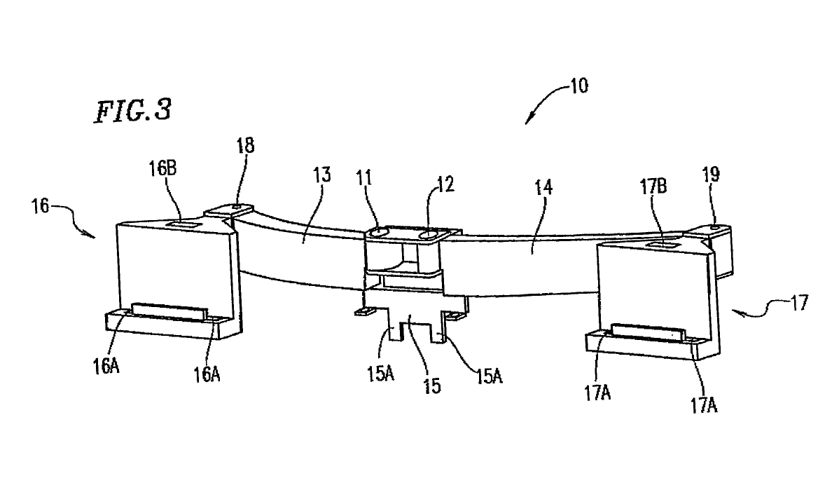

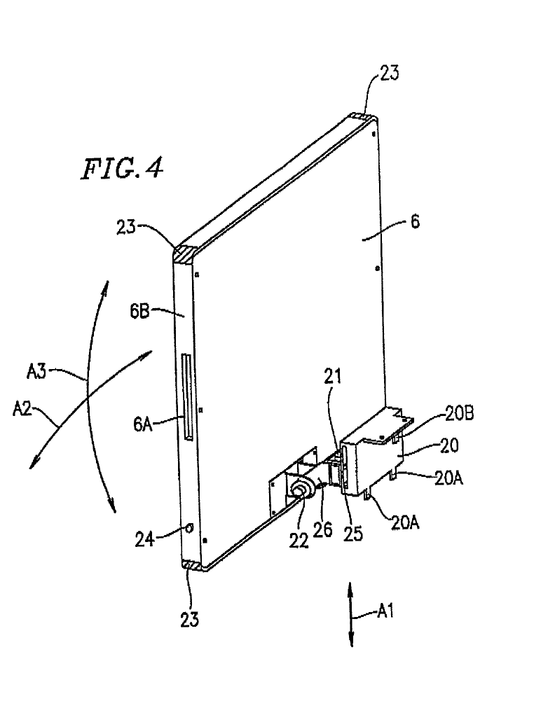

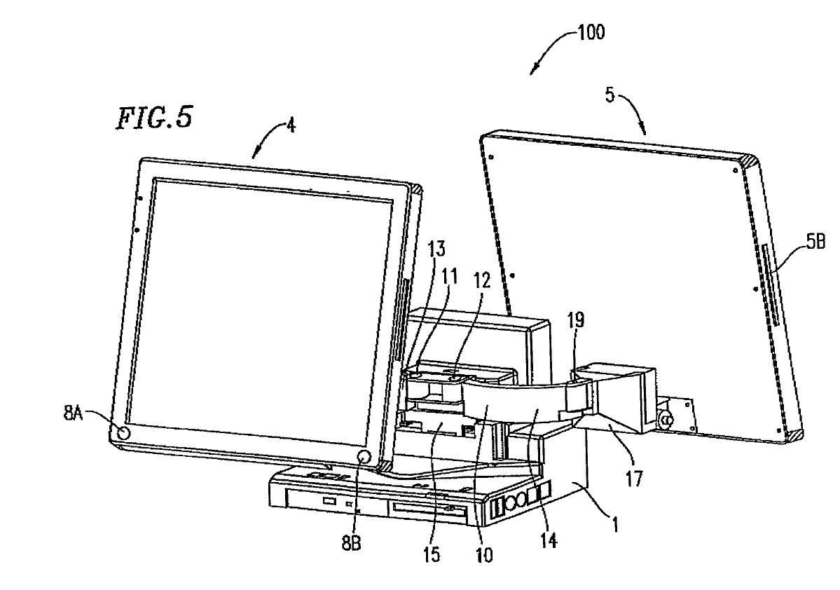

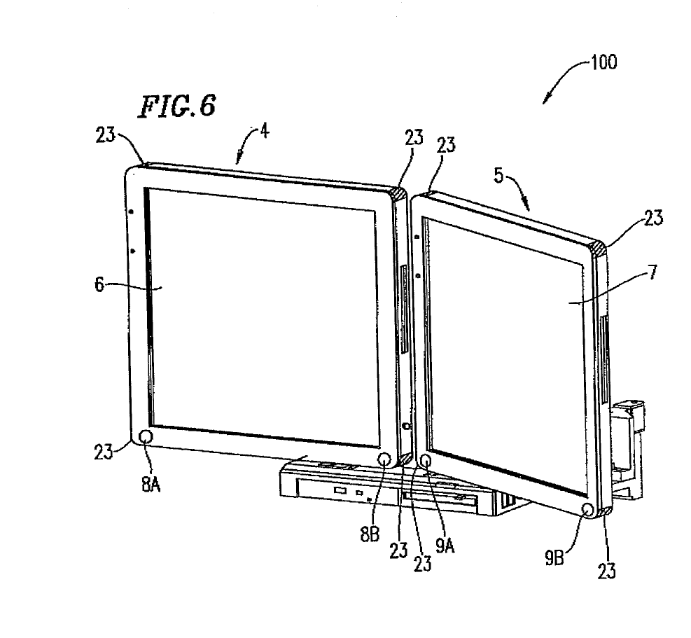

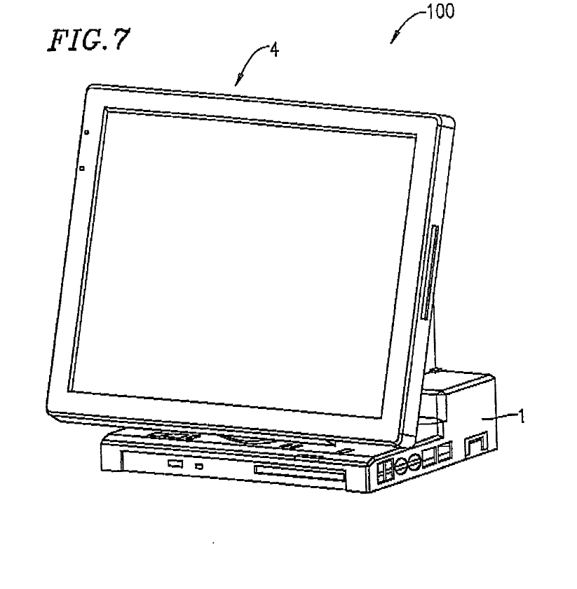

FIG. 1 is a perspective view showing an outward appearance of a personal computer which is an information processing apparatus according to one embodiment of the present invention. FIG. 2 is a perspective view showing an outward appearance of a main body of the personal computer. FIG. 3 is a perspective view showing an outward appearance of an arm unit. FIG. 4 is a perspective view showing an outward appearance of a display section. FIGS. 5 and 6 are perspective views each showing an exemplary arrangement of the display section when the direction of a face of the display section is changed. FIG. 7 is a perspective view showing an outward appearance of the personal computer when the display section is directly mounted on the main body.

In FIG. 1, reference numeral 1 denotes a main body of a personal computer 100. The main body 1 includes control circuits (not shown), such as a CPU, etc., a power supply section (not shown), a CD-ROM drive device 2, and an FD drive device 3 in which a floppy disk can be inserted. Reference numerals 4 and 5 denote display sections. The display sections 4 and 5 respectively include liquid crystal display units 6 and 7, and speakers 8A and 8B, and 9A and 9B in a bottom side of a respective front fade.

In the present embodiment, a single CPU controls both display sections 4 and 5. However, the present invention is not limited to such an arrangement. A plurality of CPUs may control a plurality of display sections. For example, two CPUs may be provided for controlling the display sections 4 and 5, respectively.

FIG. 2 solely shown the main body 1 from which the display sections 4 and 5 have been removed. The main body 1 has a protruding support stand 1A on the backside thereof. The support stand 1A has cavities 1B and 1C formed therein.

FIG. 3 shows an arm unit 10. Arms 13 and 14 are horizontally rotatably attached to a base 15 by first hinge portions 11 and 12, respectively. Reference numerals 16 and 17 denote attaching portions in which cavities 16A and 16B and 17A and 17B are respectively formed. The attaching portions 16 and 17 are horizontally rotatably attached to the arms 13 and 14 by second hinge portions 18 and 19, respectively. The base 15 has protrusions 15A for engaging the cavities 1B formed in the support stand 1A shown in FIG. 2.

FIG. 4 shows a backside of the display section 4 of FIG. 1. The liquid crystal display unit 6 is attached to an engagement unit 20 by a third hinge portions 21 so as to be rotatable both along a horizontal direction (direction represented by arrow A2) and the liquid crystal display unit 6, is also rotatable at a fourth hinge portion 22 along a tilting direction (direction represented by arrow A3). Furthermore, in a side face 6B of the liquid crystal display unit 6, a groove 6A is formed for connecting with another display section, i.e., the display section 5, (not shown in FIG. 4). A side face of the display section 5 which faces the side face 6B of the liquid crystal display unit 6 has a protrusion (not shown) formed in a shape which fits into the groove 6A for engaging with the liquid crystal display unit 6. Similarly, the liquid crystal display unit 6 also has a protrusion on a side face opposite to the side face 6B. Reference numeral 23 denotes elastic rubber sheets which are attached to four corners of a periphery of the liquid crystal display unit 6. Reference numeral 24 denotes a detection switch for detecting the connection of the display section 4 with the display section 5 by depression of the switch 24. The engagement unit 20 has protrusions 20A and 20B for respectively engaging with the cavities 16A and 16B formed in the attaching portion 16 of the arm unit 10 (FIG. 3). The engagement unit 20 also has a slide section 25, with which a bracket connected to the liquid crystal display unit 6 can be moved along a vertical direction (direction represented by arrow A1).

The display section 5 has the completely same structure as that of the display section 4 (FIG. 4), and therefore, the description thereof is omitted.

Now, arrangements of the personal computer 100 having the above structure are described.

First, the protrusions 15A formed in the base 15 of the arm unit 10 shown in FIG. 3 are inserted into the cavities 1B formed in the support stand 1A of the main body 1 shown in FIG. 2. Then, the protrusions 20A and 20B formed in the engagement unit 20 of the display section 4 shown in FIG. 4 are inserted into the cavities 16A and 16B formed in the attaching portion 16 of the arm unit 10, thereby attaching the display section 4 to the attaching portion 16. Similarly, the display section 5 is attached to the attaching portion 17.

The display sections 4 and 5 are horizontally rotatable by the first hinge portions hand 12, the arms 13 and 14, and the second hinge portions 18 and 19. Exemplary arrangements of the personal computer 100 are shown in FIGS. 1, 5 and 6.

FIG. 1 shows a most frequently used arrangement of the personal computer 100 where the two display sections 4 and 5 are connected. In this case, the protrusion (not shown) formed in a side face of the display section 5 fits into the groove 6A (FIG. 4) formed in a side face of the display section 5, whereby the display sections 4 and 5 are connected. In this arrangement, screen faces of the display sections 4 and 5 are placed on the same plane. The display sections 4 and 5 are kept integrally connected with each other as shown in FIG. 1. Therefore, the display sections 4 and 5 can be moved together to a position in which a user can comfortably carry out operation with the personal computer 100.

As shown in FIG. 4, the liquid crystal display unit 6 of the display section 4 is rotatable by the fourth hinge portion 22 along a tilting direction (direction represented by arrow A3), and thus can be set to any tilt angle. Moreover, the liquid crystal display unit 6 of the display section 4 is rotatable by the third hinge portion 21 along a horizontal direction (direction represented by arrow A2). Thus, even if the liquid crystal display unit 6 is tilted at any tilt angle, the display section 4 can be connected to the display section 5. Furthermore, the liquid crystal display unit 6 can be shifted along a vertical direction (direction represented by arrow A1), whereby the height of the liquid crystal display unit 6 can be adjusted. Such is the same for the display section 5.

In the above example, the display sections 4 and 5 are slid vertically by the respective slide sections 25 (FIG. 4). However, if the arrangement in which the screen faces of the display sections 4 and 5 are placed on the same plane is mainly employed during a user's operation, it is preferable to provide the base 15 of the arm unit 10 with a slide mechanism similar to the slide section 25 (FIG. 4) for vertically sliding the two display sections 4 and 5 together by only vertically moving the arm unit 10.

Furthermore, when the display sections 4 and 5 are connected as shown in FIG. 4, the detection switch 24 detects the connection of the display section 4 and 5 by depression of the switch 24. In response to the detection of connection, the speakers 8B and 9A near an interface between the display section 4 and 5 are turned off, and the user can normally listen to stereophonic sound from the speakers 8A and 9B.

In this arrangement, since the display sections 4 and 5 are placed on substantially the same plane, the display sections 4 and 5 can be used as if they were a single large screen. Therefore, a plurality of windows can be displayed at one time in such a manner that all of the windows can be easily observed. In this case, an area for displaying data can be enlarged as compared to a case of a single display section, and accordingly, work efficiency can be improved.

In the present embodiment, a protrusion is fit into a groove for connecting the two display sections 4 and 5. However, the present invention is not limited to such a structure. Any connection structure may be used within the scope of the present invention. For example, an attraction power between magnets having opposite polarities may be utilized.

FIG. 5 shows an arrangement of the personal computer 100 where the display sections 4 and 5 are placed back to back so that material displayed in the display section 4 is also displayed in the display section 5 for a person who is situated at an opposite side of the personal computer 100 and faces a user of the personal computer 100. The display section 4 is positioned using the first hinge portion 11, the arm 13, and the second hinge portion 18 (see FIG. 3) so as to face the user. The display section 5 is horizontally turned around using the first hinge portion 12, the arm 14, and the second hinge portion 19 (see FIG. 3) so that the person facing the user can observe the face of the display section 5. With such an arrangement, the personal computer 100 can be used such that the user observes the display section 4 while the person at the opposite side observes the display section 5. Each of the two display sections 4 and 5 can separately turn its face both horizontally (direction A2 in FIG. 4) and vertically (direction A3 in FIG. 4) so as to adjust the tilt angle thereof. Moreover, each of the display sections 4 and 5 can be separately shifted along a vertical direction (direction A1 in FIG. 4) so as to adjust the height thereof. Furthermore, in this arrangement, all of the speakers 8A, 8B, 9A, and 9B are turned on, and accordingly, stereophonic sound can be normally output from each of the display sections 4 and 5.

With such an arrangement of the display sections 4 and 5, a user can efficiently carry out operation for a person who faces the user. Such a personal computer 100 can provide significant work efficiency: for example, a sales personnel can explain a product for sale to a client who faces the sales personnel while the sales personnel observes the display section 4 and the client observes the display sections 5. Specifically, for example, the personal computer 100 can be used for face-to-face sales in a stock company.

FIG. 6 shows an arrangement of the personal computer 100 where one display is used as a main screen while the other display is used as a subordinate screen. In FIG. 6, the display section 4 is used as a display for operation (main screen) and the display section 5 is used as a display for reference (subordinate screen). The display section 4 (main screen) is positioned so that the screen thereof faces the user's is face, and the display section 5 (subordinate screen) is positioned so that the display section 5 is slightly slanted with respect to the screen face of the display section 4. Each of the two display sections 4 and 5 can separately have its face turned both horizontally and vertically so as to adjust the tilt angle thereof, and can be separately shifted along a vertical direction so as to adjust the height thereof.

With the above positioning of the two display sections 4 and 6, the two display sections 4 and 5 are placed in an optimal position, such that the user can comfortably observe the display sections 4 and 5 and carry out operations while sitting with an easy posture. Moreover, with the screen for reference (display section 5), another window different from a window displayed on the screen for operation (display section 4) can be displayed on the screen for reference (display section 5) during operation. Therefore, efforts to open/close windows on a screen are significantly reduced, and accordingly, work efficiency is considerably improved. Furthermore, efforts to print out materials which are now displayed on a screen for reference are also significantly reduced.

Furthermore, the elastic rubber sheets 23 are attached on four corners of a periphery of each of the liquid crystal display units 6 and 7. With such rubber sheets, for example, even if any of the corners of one of the liquid crystal display units 6 and 7 contacts a screen face of the other of the liquid crystal display units 6 and 7 when the liquid crystal display units 6 and 7 are moved to be set in such an arrangement shown in FIGS. 1, 5, or 6, breakage of the screen face can be prevented.

FIG. 7 shows an alternative arrangement of the personal computer 100 where the display section 4 is directly mounted on the main body 1. In this case, the protrusions 20A and 20B of the engagement unit 20 (FIG. 4) are inserted into the cavities 1B and 1C formed in the support stand 1A (FIG. 2) in order to attach the display section 4 to the main body 1.

As shown in FIG. 7, when only one display section (the display section 4) is required for operation, the arm unit 10 and the other display section 5 can be removed. Accordingly, a three-dimensional space which is occupied by the display sections can be reduced. Even in this arrangement, due to the function of the engagement unit 20 (FIG. 4), the display section 4 can turn its face both horizontally and vertically so as to adjust the tilt angle thereof, and moreover can be shifted along a vertical direction so as to adjust the height thereof.

In the present embodiment, the two display sections 4 and 5 are mounted on the single arm unit 10. However, it is possible to mount three or more display sections on a single arm unit by increasing the number of arms of the arm unit. Naturally, a display device including a single arm and a single display section is within the scope of the present invention.

Furthermore, in the present embodiment, the arm unit 10 and the display sections 4 and 5 are detachable. However, the arm unit 10 may be undetachably attached to the support stand 1A, or the display sections 4 and 5 may be undetachably attached to the arm unit 10. In such a case, for example, although it is not possible to reduce the number of display sections by arranging the personal computer 100 as shown in FIG. 7 in which the arm unit 10 and the display section 5 are removed so that the display section 4 is directly mounted on the support stand 1A, the degree of freedom of the position of the display sections 4 and 5 can be increased.

Further still, in the present embodiment, the information processing apparatus including display sections has been described. However, it is matter of course that the present invention can be applied to a display device itself which is not an information processing apparatus.

As described hereinabove, according to the present embodiment, the degree of freedom of the position of the display sections 4 and 5 can be increased. Therefore, various arrangements are possible: two display sections can be placed in a back-to-back position; and one of the two display sections can be used as a main screen while the other display section which can be placed adjacent to the main screen and slightly slanted with respect to the screen face of the main screen to be used as a subordinate screen. Furthermore, the number of display sections can be changed according to various operation modes. Thus, the present invention can provide advantageous effects, such as improvement in an operation environment, for example, a large screen area can be obtained without increasing a space on a desk for installing devices.

Thus, according to the present invention, there is provided a display device and an information processing apparatus including a plurality of display sections in which a degree of freedom of the position of the display sections is increased.

Furthermore, according to the present invention, there is provided a display device and an information processing apparatus in which the number of display sections can be changed according to the operation mode of the display sections.

Various other modifications will be apparent to and can be readily made by those skilled in the art without departing from the scope and spirit of this invention. Accordingly, it in not intended that the scope of the claims appended hereto be limited to the description as set forth herein, but rather that the claims be broadly construed.

What is claimed is:

1. A display device, comprising:
support stand;
an arm unit mounted on the support stand; and
one or more display sections mounted on the arm unit,
wherein the arm unit includes one or more arms for respectively supporting the one or more display sections,
the one or more arms are rotatably attached to the arm unit so that the one or more display sections can be moved to such positions that a user can comfortably observe the one or more display sections, and
the one or more display sections are each rotatably attached to a respective one of the one or more arms so that the one or more display sections can be moved to such positions that the user can comfortably observe the one or more display sections.

2. A display device according to claim 1, wherein:
the one or more display sections are a plurality of display sections;
the one or more arms are a plurality of arms; and
at least one of one of the plurality of display sections and one of the plurality of arms which supports the one of the plurality of display sections is rotatable such that the one of the plurality of display sections is placed in a back-to-back position with respect to another one of the plurality of display sections.

3. A display device according to claim 1, wherein:
the one or more display sections are a plurality of display sections;
the one or more arms are a plurality of arms; and
the plurality of display sections and the plurality of arms are rotatable such that the plurality of display sections are placed on substantially the same plane so as to face in a same direction.

4. A display device according to claim 1, wherein the arm unit includes:
one or more first hinges for rotatably supporting the one or more arms; and
one or more second hinges for rotatably supporting the one or more display sections.

5. A display device according to claim 4, wherein:
each of the one or more first hinges are provided at one end of each of the one or more arms; and
each of the one or more second hinges are provided at the other end of each of the one or more arms.

6. A display device according to claim 4, wherein:
the one or more first hinges each horizontally rotatably support a respective one of the one or more arms; and
the one or more second hinges each horizontally rotatably support a respective one of the one or more display sections.

7. A display device according to claim 1, wherein:
the arm unit is detachably mounted on the support stand; and
the one or more display sections are detachably mounted on the arm unit.

8. A display device according to claim 1, wherein:
the support stand includes a first attaching portion; and
the arm unit further includes a first engaging portion for engaging with the first attaching portion.

9. A display device according to claim 1, wherein:
the arm unit further includes one or more first attaching portions for respectively attaching the one or more display sections to the arm unit; and
each of the one or more display sections includes,
a first engaging portion for engaging with each of the one or more first attaching portions,
a display unit for displaying information, and
a first hinge for rotatably supporting the display unit.

10. A display device according to claim 9, wherein:
the support stand includes a second attaching portion for attaching the arm unit to the support stand;
the arm unit includes a second engaging portion for detachably engaging with the second attaching portion included in the support stand;
each of the first engaging portions included in each of the one or more display sections detachably engages with each of the one or more first attaching portions included in the arm unit; and
the second engaging portion included in the arm unit and the first engaging portion included in each of the plurality of display sections have a substantially identical shape.

11. A display device according to claim 9, wherein the first engaging portion included in one of the one or more display sections which has been detached from one of the one or more first attaching portions included in the arm unit engages with the second attaching portion included in the support stand from which the second engaging portion included in the arm unit has been detached.

12. A display device according to claim 9, wherein the first hinge horizontally rotatably supports the display unit.

13. A display device according to claim 9, wherein each of the one or more display sections further includes a second hinge for supporting the display unit rotatably in a tilting direction.

14. A display device according to claim 13, wherein the first hinge is provided between the first engaging portion and the second hinge.

15. A display device according to claim 9, wherein each of the display sections includes a slide section for vertically sliding up and down the display unit.

16. A display device according to claim 1, wherein the arm unit includes a slide section for vertically sliding up and down the one or more arms.

17. A display device according to claim 1, wherein:
the one or more arms are a plurality of arms;
the plurality of arms are all placed at a same height; and
the plurality of arms are horizontally rotatably attached to the arm unit.

18. A display device according to claim 1, wherein:
the one or more display sections are a plurality of display sections;
one of the plurality of display sections includes a first connecting portion; and
another one of the plurality of display sections which is adjacent to the one of the plurality of display sections includes a second connecting portion formed so as to connect with the first connecting portion.

19. A display device according to claim 18, wherein:
the first connecting portion has a protruding shape; and
the second connecting portion has a concave shape which engages with the protruding shape of the first connecting portion.

20. A display device according to claim 18, wherein:
the first connecting portion includes a first magnet; and
the second connecting portion includes a second magnet having a polarity opposite to that of the first magnet.

21. A display device according to claim 1, wherein:
each of the one or more display sections has speakers at right and left sides thereof; and
when one of the one or More display sections is connected to another one of the one or more display sections, speakers of the connected display sections which are present near an interface between the connected display sections are turned off.

22. A display device according to claim 1, wherein each of the one or more display sections includes elastic bodies at corner areas thereof.

23. A display device according to claim 1, wherein:
the one or more display sections are one display section; and
the one or more arms are one arm.

24. A display device, comprising:
a support stand; and
a display section mounted on the support stand,
wherein the support stand includes a first attaching portion for detachably attaching the display section to the support stand,
the display section includes a first engaging portion for detachably engaging with the first attaching portion,
the first attaching portion included in the support stand can engage with a second engaging portion included in an arm unit,
a second attaching portion included in the arm unit can engage with the first engaging portion included in the display section, and
the first engaging portion included in the display section and the second engaging portion included in the arm unit have a substantially identical shape.

25. An information processing apparatus, comprising:
a support stand;
an arm unit mounted on the support stand;
one or more display sections mounted on the arm unit; and
one or more CPUs for controlling the one or more display sections,
wherein the arm unit includes one or more arms for respectively supporting the one or more display sections, the one or more arms are rotatably attached to the arm unit so that the one or more display sections can be moved to such positions that a user can comfortably observe the one or more display sections, and
the one or more display sections are rotatably attached to the one or more arms so that the one or more display sections can be moved to such positions that the user can comfortably observe the one or more display sections.

26. An information processing apparatus according to claim 25, wherein:
the one or more CPUs are one CPU; and
the one CPU controls the one or more display sections.

27. An information processing apparatus according to claim 25, wherein:
the one or more CPUs are a plurality of CPUs; and
the plurality of CPUs respectively control the one or more display sections.
